(19) United States
(12) Patent Application Publication
(10) Pub. No.: US 2009/0306840 A1
(43) Pub. Date: Dec. 10, 2009

(54) VISION-BASED AUTOMATED LANDING SYSTEM FOR UNMANNED AERIAL VEHICLES

(76) Inventors: Kevin P. BLENKHORN, Arlington, VA (US); Stephen V. O'Hara, Fort Collins, CO (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/419,975

(22) Filed: Apr. 7, 2009

Related U.S. Application Data
(60) Provisional application No. 61/043,360, filed on Apr. 8, 2008.

(51) Int. Cl. G05D 1/00; G06G 7/70; B64C 19/00

(52) U.S. Cl. 701/16; 244/75.1

(57) ABSTRACT

The invention relates generally to the control and landing of unmanned aerial vehicles. More specifically, the invention relates to systems, methods, devices, and computer readable media for landing unmanned aerial vehicles using sensor input and image processing techniques.

### CROSS-REFERENCE TO RELATED APPLICATIONS

This application claims the benefit under 35 U.S.C. § 119(e) of U.S. Provisional Application No. 61/043,360, filed Apr. 8, 2008, the entirety of which is incorporated herein by reference.

### FIELD OF THE INVENTION

The present invention relates generally to the control and landing of unmanned aerial vehicles. More specifically, the present invention relates to systems, methods, devices, and computer readable media for landing unmanned aerial vehicles using sensor input and image processing techniques.

### BACKGROUND OF THE INVENTION

Unmanned aerial vehicles (UAVs) are aircraft that fly without onboard pilots. They rely on complete or partial automation for control during their flight. UAVs have become increasingly popular for use in support of military operations, but the logistical complexity of UAV control, and the resultant cost, often makes their use burdensome. First, the soldiers who fly UAVs will always have other duties or circumstances which require them to be able to draw their attention away from their flight controls for at least some period of time. Second, larger UAVs require highly trained pilots for takeoff and landing. As a result, units which fly large UAVs often have one set of crew to fly the mission phase and a second crew for the takeoff and landing phases. These larger UAVs also must be landed on a prepared runway, which requires soldiers to clear a landing location. Micro and small UAVs require somewhat less overhead than larger UAVs. Micro and small UAVs do not require two crews—they are usually flown and landed by the same soldiers throughout the entire mission—but flying is often the secondary occupational specialty of the pilots who operate these UAVs. While micro and small UAVs can usually land in any open area at a non-prepared airfield, infrequent practice of UAV landings often results in hard or inexpert landings, which can damage the UAV.

Automated landing systems can mitigate some of the risk associated with landing a UAV by improving the accuracy of the landing touchdown point. This reduces wear and tear on the vehicle, and reduces both the training level and active attention required of the operator. First, an automated landing system can more accurately control the velocity of the UAV—both speed, and direction—than a human operator. This increased level of control can reduce bumps and scrapes on landing. Additionally, the higher level of control can reduce the soldiers' work in preparing a runway. With an automated landing system, the UAV can often be guided to a small, more precise landing area, which reduces the amount of preparation work required from the soldiers. Finally, the use of automation allows human operators to oversee the landing, but permits them to focus their attention elsewhere for most of that time.

Several types of automated landing systems are currently available in different UAVs. GPS and altimeter-based systems are the most common automated landing systems. In these systems, a human operator enters the latitude and longitude of the intended landing location, and the ground altitude, into a software controller. The operator then creates an approach pattern with waypoints, and designates the direction of landing. The autopilot flies the aircraft on the designated approach pattern and lands the aircraft at the intended landing location, within the accuracy limits of the GPS navigation system. To reduce the impact of landing, it is possible to either cut power or deploy a parachute at a preprogrammed location shortly before touchdown.

GPS and altimeter-based systems are sufficient for establishing the aircraft in a landing pattern and beginning the approach descent, but the actual touchdown control is less than optimal. Although GPS latitude and longitude are extremely accurate, altitude calculations may be off by several meters. Pitot-static systems, which use pressure-sensitive instruments (e.g. air pressure-sensitive instruments) to calculate the aircraft's airspeed and altitude, are generally more accurate than GPS-based systems, but are susceptible to similar problems—changes in ambient air pressure during the flight can affect altitude measurements. In both cases, then, the aircraft may touch down several meters before or after reaching its intended landing site. An off-site landing can easily damage the aircraft when working on an unprepared landing strip or in an urban area.

Certain UAVs use energy-absorption techniques for landing. These are simple for the operator to use and have a high rate of survivability. A human operator programs the latitude and longitude of the intended landing location, the ground altitude, and an approach pattern into a software controller. Using GPS, these aircraft fly the approach path, and then just before reaching the intended landing site, enter a controlled stall. The stall causes the aircraft to lose forward speed and drop to the ground. Although these UAVs sustain a heavy impact, they are designed to break apart and absorb the energy of the impact without damaging the airframe. Advantages of this system are that it requires minimal control input for the landing, and new operators are able to learn to use it quickly and effectively. A major disadvantage, however, is that this system is not portable to many other UAVs. It requires specially-designed aircraft that are capable of absorbing the shock of hard belly-landings. Larger, heavier aircraft create greater kinetic energy in a stall and would most likely suffer significant airframe damage if they attempted this sort of landing. Additionally, aircraft must also have adequate elevator authority to enter and maintain a controlled stall. Finally, any payloads installed on the UAV would need to be specially reinforced or protected to avoid payload damage.

As an alternative to GPS, there are several radar-based solutions to auto-landing. These systems track the inbound trajectory of the aircraft as they approach the runway for landing, and send correction signals to the autopilots. Radar-based systems have the advantage of working in fog and low-visibility conditions that confound visual solutions. Their primary disadvantage is that they require substantial ground-based hardware, which makes them impractical for use with small and micro UAVs. The use of ground-based hardware also increases their logistics footprint for larger UAVs, which may reduce their practicality in expeditionary warfare.

Although not automated, the U.S. Navy has used a visual-based system for manually landing aircraft on aircraft carriers since the 1940s. Aircraft carrier pilots currently use a series of Fresnel lenses, nicknamed the ‘meatball’, to guide them to the aircraft carrier during landing. Different lenses are visible to the pilot depending on whether the is above, below, left, or right of the ideal approach path. The pilot steers onto the proper glideslope and lineup by following the lights on the meatball, and maintains that approach path all the way to touchdown. The meatball is a proven system for directing the landing of Navy aircraft. However, it is expensive and requires accurate human pilot directed adjustment to effect the proper glideslope, so it would not be practical to use it for most UAV operations.

### BRIEF SUMMARY OF THE INVENTION

The present invention discloses vision-based automated systems and methods for landing unmanned aerial vehicles. The system of the invention includes one or more UAVs, and one or more targets, of known geometry, positioned at one or more intended landing locations. The system further includes one or more sensors coupled to each UAV, such that at least one sensor is aligned with the direction of movement of the UAV, and captures one or more images in the direction of movement of the UAV. The system further includes at least one processor-based device, which determines the visual distortion of at least one target visible in one or more of the captured images as a function of the UAV's current position. This processor-based device calculates the UAV's current glideslope and lineup angle, and adjusts the current glideslope and alignment of the UAV to an intended glideslope and lineup angle, so as to safely land the UAV.

### BRIEF DESCRIPTION OF THE DRAWINGS

FIG. 1 depicts a UAV landing.

FIG. 2 depicts a target in the shape of a bilaterally symmetric cross.

FIG. 3 depicts a UAV properly aligned with a target, such that the target does not appear skewed.

FIG. 4 depicts a UAV aligned to the right of a target, such that the target appears skewed.

FIG. 5 depicts a UAV currently flying above the proper glideslope.

FIG. 6 depicts a UAV currently flying to the right of the proper lineup.

FIG. 7 depicts a method for landing a UAV.

FIG. 8(a) shows a wave-off procedure.

FIG. 8(b) shows a wave-off procedure initiated by a human operator.

FIG. 8(c) shows a wave-off procedure initiated upon the occurrence of a preprogrammed condition.

FIG. 8(d) shows a wave-off procedure initiated upon a determination that the UAV cannot land safely.

### DETAILED DESCRIPTION OF THE INVENTION

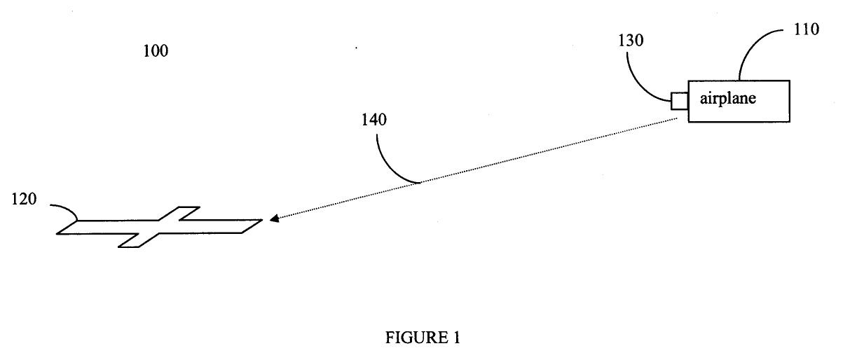

The present invention provides a vision-based automated system for landing UAVs, as shown in FIG. 1. The system 100 includes a UAV 110, which may be any micro, small, or large UAV. The system of the invention also includes one or more targets 120 positioned at one or more intended landing locations. A target must be of a known geometry and possess a minimum of three salient reference points (known hereinafter as “signature corners”). Signature corners are any reference points which can be used to regenerate the shape of an object. Examples of targets 120 may include, but are not limited to, runways, taxiways, buildings, or the entire airfield. In a preferred embodiment, the target 120 is a bilaterally symmetric cross.

The placement of the target 120 at the intended landing location may be permanent or fixed (i.e. removable). In one embodiment of the invention, the target 120 may be painted on a runway or other landing site. In another embodiment, the target 120 may be fixed on a portable mat, such that the mat can be placed on the landing site when necessary, but stored away when out of use. In yet another embodiment, the target 120 may be designated by any light source, such as chemical lights or infrared strobe lights, on three or more signature corners 250 of the target 120.

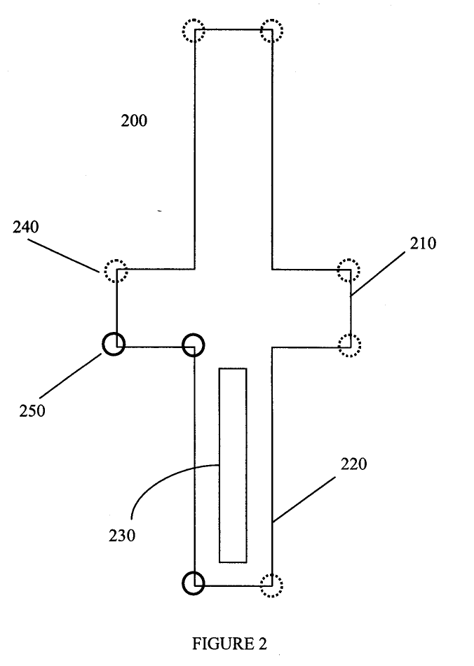

FIG. 2 depicts a target 120 in the shape of a bilaterally symmetric cross 200. This bilaterally symmetric cross 200 includes a horizontal arm 210 and a vertical arm 220. In a preferred embodiment, the vertical arm 220 is longer than the horizontal arm 210. The length of the vertical arm 220 may be longer than the length of the horizontal arm 210 by any a-priori known ratio. There is no hard limit on the ratio of the relative lengths of the horizontal 210 and vertical arms 220. However, the absolute lengths of the horizontal 210 and vertical arms 220 must be large enough that they can be detected by a sensor 130 on the UAV 110, and not so large that the UAV 110 will be flying over the target 120 for more than the last few seconds of the flight. In a preferred embodiment, the vertical arm 220 is ten times the length of the horizontal arm 210. In a most preferred embodiment, the vertical arm 220 is five times the length of the horizontal arm.

One end of the vertical arm 220 may be pre-designated as an approach end by a special marker 230. The special marker 230 can be any marker of known geometry capable of identifying a single arm or piece of a target 120. Special markers 230 may be of any color or easily-identified shape that clearly differentiates the special marker 230 from the rest of the target 120, such as, for example, a star, rectangle, or circle. The special marker 230 must indicate the approach end of the target 120 without interfering with the sensor's 130 ability to measure the length of the arm. In a preferred embodiment, as shown in FIG. 2, the special marker is a rectangular stripe positioned within the outline of the vertical arm 220. The special marker may be any color that is distinct from the color of the target 120. For example, in one embodiment, the special marker 230 may be a circle that appears along the arm marking the approach end. In another embodiment, the special marker 230 may be a green arm designating the approach end, while the remainder of the target 120 is orange. In still another embodiment, the special marker 230 may be a cross-bar that is painted across the end of the approach arm in the same color as the rest of the target. In a preferred embodiment, the special marker 230 is a green rectangle in the middle of the approach arm and the target 120 is red.

It should be noted, however, that despite the use of particular colors and lengths as described above, the respective lengths of the horizontal arm 210 and the vertical arm 220, and the colors of the cross 200 and the special marker 230, may be varied as applicable to the situation, provided that the target 120 is of a shape that is identifiable and is of a known configuration.

In accordance with a preferred embodiment, the system includes at least one sensor 130, capable of detecting the targets 120, that is connected to the UAV 110, so that the sensor 130 is aligned with the direction of movement 140 of the UAV 110, and captures one or more images of the landscape in the direction of movement 140 of the UAV 110. In a preferred embodiment of the invention, the sensor 130 is a digital camera, which produces a digital image of the landscape in the direction of movement of the UAV 110. In alternative embodiments, the sensor 130 may be a single-lens reflex (SLR) camera, or an infrared camera, or any other device capable of capturing one or more images of the landscape and detecting the target 120 placed at the intended landing location.

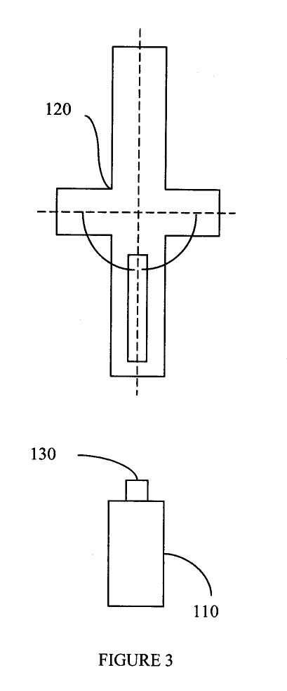

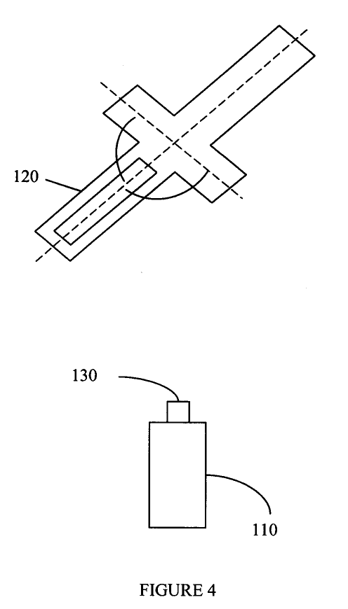

The system determines the visual distortion of any target 120 visible in one or more of the captured images as a function of the UAV's 110 current position. As the UAV's 110 position changes with respect to the position of the target 120, the target 120 will appear to be skewed, or distorted, in any captured images. FIG. 3 shows the UAV 110 in one position relative to the target. FIG. 4 shows the UAV in another position relative to the target, and illustrates how the image of the target will appear skewed. Using precise measurements of the extent to which the image is skewed, it is possible to determine the UAV's 110 current approach path, which, may not be the intended approach path 585.

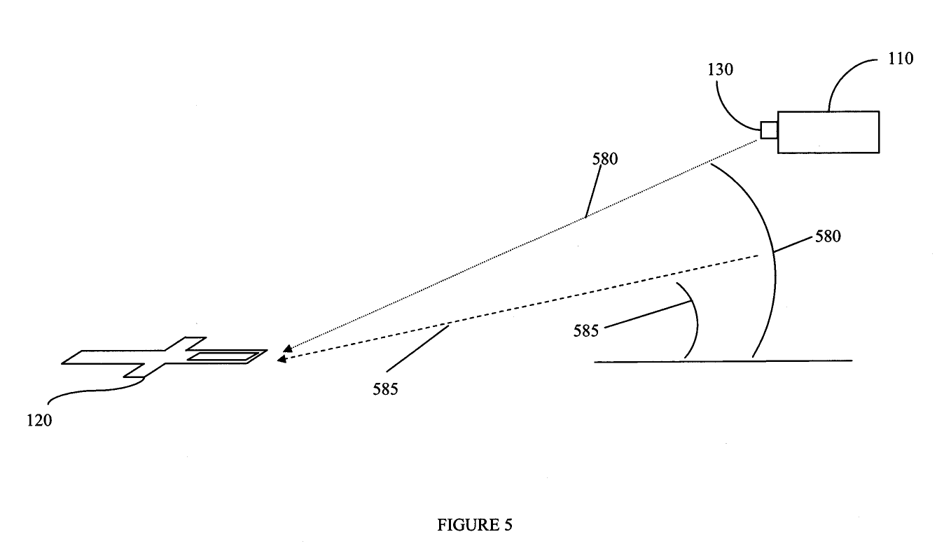

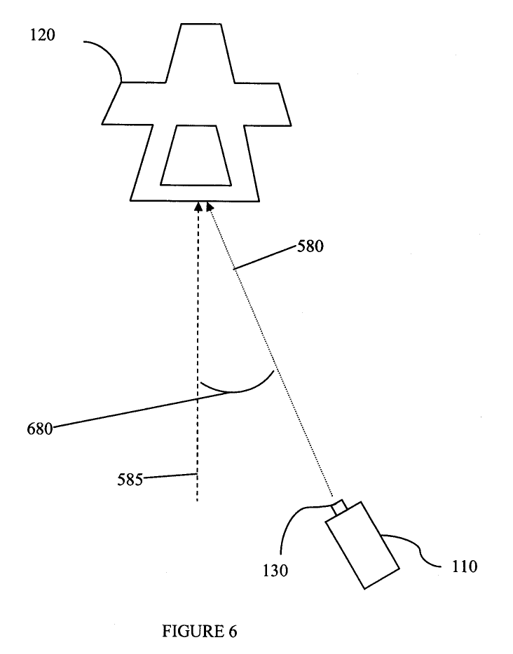

FIG. 5 depicts a UAV 110 with a current glideslope 580 above the intended glideslope 585. The glideslope is the measure of the angle between the UAV's 110 path and the XY-plane created by the target 120 placed on the landing surface. FIG. 6 shows a UAV aligned to the right of the target 120. The UAV's 110 current lineup angle 680 is measured from the XY-axis of the target 120, as oriented from the intended direction of approach. The calculated current glideslope 580 and lineup angle 680 are then used to adjust the current approach path 580 of the UAV 110 to the intended approach path 585, by forcing the UAV 110 to adjust its altitude and direction. In one embodiment of the invention, the current glideslope 580 and the current lineup angle 680 can be sent to an autopilot control loop, which then adjusts the UAV's 110 altitude and direction.

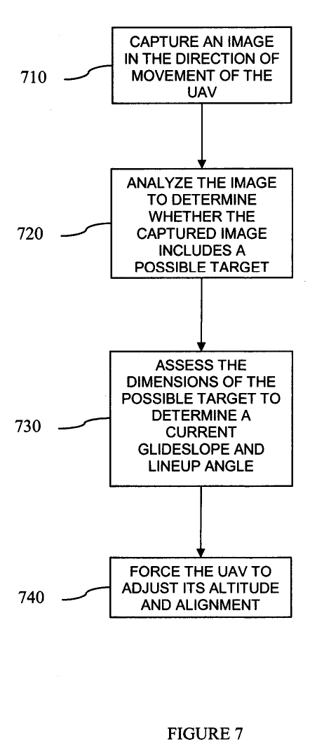

The present invention also includes methods for landing a UAV, as shown in FIG. 7. The method may include capturing an image in the direction of movement of the UAV 710. The image may be captured by one or more sensors fixed to the UAV. Examples of such sensors may include, but are not limited to traditional SLR cameras, infrared cameras, and digital cameras. In a preferred embodiment, the image is captured by a digital camera, such that the image is composed of pixels.

The method of the invention may also include analyzing the image to determine whether it includes a target 720. In a preferred embodiment, the method includes analyzing the image to determine whether the image contains any objects which may be a target, which will be referred to as a “possible target,” and to determine whether that possible target is the “actual target” where the UAV is intended to land. In one embodiment, the analyzing may be performed by a human operator, who manually confirms that the image includes an actual target. In an alternative embodiment, the analyzing may be performed by image processing techniques (e.g. computer-based image processing techniques). Examples of such targets may include, but are not limited to, runways, taxiways, buildings (e.g. building rooftops), or the entire airfield. In a preferred embodiment, the target is a bilaterally symmetric cross (e.g. a bilaterally symmetric cross placed horizontally on the landing surface).

Image processing may be done in any manner known to one of skill in the art. In one embodiment, image processing may include identifying the outline of the possible target. In a preferred embodiment, the outline of the possible target may be determined by first identifying the region of the captured image which contains a contiguous area dominated by the color of the actual target. For example, if the actual target is red, any contiguous region in the image which is red is noted. The red channel of the image can then be converted into a binary mask, such that, for example, the red region is designated by a ‘1’, and all other colors are designated as a ‘0’. It should be noted that any equivalent binary formulation such as, for example, ‘true’ and ‘false’, or ‘positive’ and ‘negative’ could also be used for the designation. For simplicity, the binary mask will hereafter be referred to with reference to ‘1’ and ‘0’, but this is not intended to limit the scope of the invention in any way. Using basic morphology operations, it is possible to smooth the silhouette of the region to form a more precise outline of the possible target.

Image processing may also include identifying at least three signature corners of the possible target. The three signature corners of the possible target may be compared to the known signature corners of the actual target. Based on the comparison, it may be determined whether the signature corners of the possible target substantially match the signature corners of the actual target.

Using the outline of the possible target, it is then possible to isolate signature corners of the possible target, and to compare the signature corners of the possible target to signature corners of the actual target. FIG. 2 illustrates the signature corners 240 of a bilaterally symmetric cross 200. If at least three signature corners 250 of the possible target substantially match at least three signature corners of the actual target, it is probable that the possible target is an actual target.

The use of a special marker 230 in the actual target may improve the accuracy of the determination whether a possible target is an actual target by creating additional signature corners. For example, if the actual target is red, but contains a green stripe, a captured image will reflect this green stripe. When the red channel of the image is converted to a binary mask, all of the green stripe will be designated as a ‘0’, or the equivalent binary inverse of the red region, appearing as if it were a hole in the possible target. This creates additional signature corners, which are comparable to the special marker 230 of the actual target. In yet another embodiment, the analysis of the image to determine whether the image contains any objects which may be a target is performed using image processing (e.g. computer-based image processing), using a technique such as that described above, with a human operator verifying that the determination made via the image processing (e.g. automated computer-based image processing) is correct.

It should be noted that other image processing techniques may also be used to analyze the image and the above examples are in no way meant to limit the scope of the invention.

The method of the invention may also include assessing the dimensions of a possible target 730 and comparing those dimensions to the known dimensions of an actual target to determine a current glideslope 580 and lineup angle 680. The present invention is capable of working with a UAV traveling on any initial glideslope. In a preferred embodiment, the glideslope is between 2 and 45 degrees. In a most preferred embodiment, the glideslope is between 3 and 10 degrees. In one embodiment of the invention, the current glideslope is determined as a function of the apparent height-to-width ratio of the target, as captured in the image taken by a digital sensor in the direction of movement of the UAV. This height-to-width ratio can be determined by the equation H/W=PAR*(h/w)*sin(α), where:

H=the apparent height of the target as captured in the image;

W the apparent width of the target as captured in the image;

PAR=the pixel aspect ratio of the sensor;

h=the known, actual height of the target;

w=the known, actual width of the target; and

α=current glideslope of the UAV.

Transforming this equation, the current glideslope can then be calculated by solving the equation α=sin⁻¹(H*w/(PAR*h*W)). These calculations, and any other calculations described herein, may be performed by software running on a processor-based device, such as a computer. The instructions associated with such calculations may be stored in a memory within, or coupled to, the processor-based device. Examples of such memory may include, for example, RAM, ROM, SDRAM, EEPROM, hard drives, flash drives, floppy drives, and optical media. In one embodiment, the processor-based device may be located on the UAV itself. In an alternative embodiment, the processor-based device may be located remotely from the UAV and may communicate wirelessly with the UAV.

There are straight-forward mathematical techniques to determine the current glideslope and the lineup angle from known measurements and constraints by solving a system of equations. In the preferred embodiment of the invention, both the current lineup angle 680 and the current glideslope 580 can be calculated by solving the system of equations generated by calculating the unit vectors for three signature corners. For example, in one embodiment, the current lineup angle 680 and the current glideslope 580 may be calculated by applying the equation

$$[ \begin{matrix}{S}_{X} \\ {S}_{Y} \\ {S}_{Z}\end{matrix} ] [ \begin{matrix}cos ( β ) & - sin ( β ) & 0 \\ sin ( β ) & cos ( β ) & 0 \\ 0 & 0 & 1\end{matrix} ] [ \begin{matrix}1 & 0 & 0 \\ 0 & cos ( α ) & - sin ( α ) \\ 0 & sin ( α ) & cos ( α )\end{matrix} ] = [ \begin{matrix}{D}_{X} \\ {D}_{Y} \\ 0\end{matrix} ] ,$$

where

S_{X}, S_{Y}, S_{Z}=world coordinates for one signature corner of the target;

D_{X}, D_{Y}=unit vector of that signature corner;

α=the current glideslope; and

β=the lineup angle,

to at least three signature corners of said target. The method may further include using the current lineup angle and current glideslope to force the UAV to adjust its altitude and alignment 740 to conform to the intended approach path 585. In one embodiment of the invention, the current glideslope and the current lineup angle can be sent to an autopilot control loop, which then adjusts the UAV's altitude and direction.

In some cases, it may be desirable to perform the method of the invention repeatedly, to ensure that the UAV maintains the intended approach path until the UAV has landed safely. The method may be repeated at any regular interval as desired.

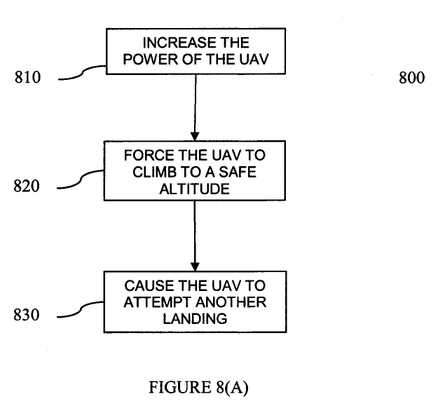

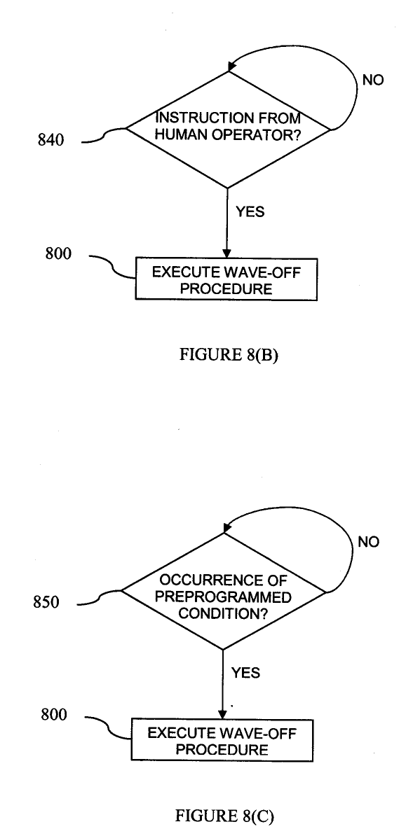

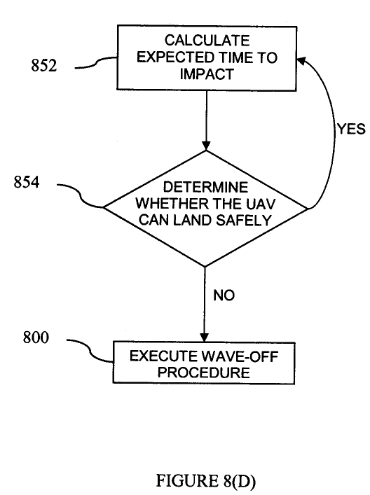

As shown in FIG. 8(a), the invention may also include executing a “wave-off” procedure to prevent the UAV from landing by 800. This method may include increasing the power of the UAV 810. The method may also include forcing the UAV to climb to a safe altitude 820. The method may further include causing the UAV to attempt another landing 830. As shown in FIG. 8(b), the wave-off procedure 800 may be initiated by a human operator 840. In an alternative embodiment, as shown in FIG. 8(c), the UAV may automatically execute this procedure 800 upon the occurrence of one or more preprogrammed conditions 850. For example, in some cases, it may not be physically possible to adjust the UAV's current path to the desired path before the UAV lands. The UAV may not be able to respond quickly enough to sufficiently shift its current glideslope or lineup angle. Therefore, in a preferred embodiment, as shown in FIG. 8(d), an expected time to impact is calculated 852, and an assessment is made, based on the physical and flight characteristics of the UAV, whether it will be possible to adjust to the desired path 854. The expected time to impact can be calculated from the rate of change of the target's apparent size compared to the known dimensions, when the UAV is flying at a constant velocity. For example, in one embodiment, the expected time to impact can be calculated using the equation

$${TTI}_{1} = \frac{{w}_{2} ( {t}_{2} - {t}_{1} )}{{w}_{2} - {w}_{1}} ,$$

where

TTI₁=expected time to impact;

t₁=the time at which a first image is captured;

t₂=the time at which a subsequent image is captured;

w₁=the apparent width of the target as captured in said first image; and

w₂=the apparent width of the target as captured in said subsequent image.

In other embodiments, the apparent height of the target or any other appropriate dimension may be used instead of width. If the expected time to impact is calculated 852, and it is determined that the UAV cannot land safely 854, the UAV will not land, but will instead execute the wave-off procedure 800.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims, in which all terms are meant in their broadest reasonable sense unless otherwise indicated therein.

What is claimed:

1. A vision-based automated system for landing unmanned aerial vehicles, said system comprising:
(i) one or more unmanned aerial vehicles;
(ii) one or more targets, of known geometry, each of said one or more targets positioned at an intended landing location; wherein said vehicle is attempting to land on at least one of said one or more targets;
(iii) at least one sensor coupled to each of said one or more vehicles, wherein said at least one sensor is aligned with the direction of movement of said one or more vehicles, and wherein said at least one sensor captures one or more images in the direction of movement of said one or more vehicles and is capable of detecting said one or more targets;
(iv) at least processor-based device, wherein said processor-based device determines the visual distortion of at least one of said one or more targets visible in said one or more images as a function of said one or more vehicles' current position, such that a current glideslope and a current lineup angle can be determined for said one or more vehicles;
and wherein said processor-based device can adjust said current glideslope and said current lineup angle of said one or more vehicles to an intended glideslope and an intended lineup angle.

2. The system of claim 1, wherein said geometry is planar geometry.

3. The system of claim 1, wherein said system sends said current glideslope and said current lineup angle to an autopilot control loop to adjust said current glideslope and said current lineup angle.

4. The system of claim 1, wherein at least one of said one or more targets is a bilaterally symmetric cross.

5. The system of claim 1, wherein at least one of said one or more targets is a building rooftop.

6. The system of claim 1, wherein at least one of said one or more targets is painted on a building.

7. The system of claim 4, wherein said bilaterally symmetric cross comprises a horizontal arm and a vertical arm.

8. The system of claim 7, wherein the length of said vertical arm is greater than the length of said horizontal arm.

9. The system of claim 8, wherein the length of said vertical arm is between two and 20 times the length of said horizontal arm.

10. The system of claim 9, wherein the length of said vertical arm is between five and 15 times the length of said horizontal arm.

11. The system of claim 10, wherein the length of said vertical arm is five times the length of said horizontal arm.

12. The system of claim 10, wherein the length of said vertical arm is ten times the length of said horizontal arm.

13. The system of claim 7, wherein one end of said vertical arm is pre-designated as an approach arm by a special marker.

14. The system of claim 13, wherein said special marker is a stripe positioned within the outline of said vertical arm.

15. The system of claim 13, wherein said special marker is rectangular.

16. The system of claim 13, wherein said special marker is any color which is a different color than said target.

17. The system of claim 16, wherein said special marker is green.

18. The system of claim 1, wherein at least one of said one or more targets is red.

19. The system of claim 1, wherein at least one of said one or more targets is a runway.

20. The system of claim 1, wherein at least one of said one or more targets is a taxiway.

21. The system of claim 1, wherein at least one of said one or more targets is a building.

22. The system of claim 1, wherein at least one of said one or more targets is the entire airfield.

23. The system of claim 1, wherein at least one of said one or more targets is permanently placed on a runway.

24. The system of claim 1, wherein at least one of said one or more targets is fixed on a portable mat.

25. The system of claim 1, wherein at least one of said one or more targets is coupled to one or more lights, wherein said lights are positioned on signature corners of said at least one of said one or more targets.

26. The system of claim 25, wherein said lights are chemical lights.

27. The system of claim 25, wherein said signature corners are non-collinear signature corners.

28. The system of claim 27, wherein said non-collinear signature corners establish a geometric two-dimensional plane of said at least one of said one or more targets.

29. The system of claim 1, wherein at least one of said one or more targets is coupled to one or more infrared strobe lights, wherein said infrared strobe lights are positioned on signature corners of said at least one of said one or more targets.

30. The system of claim 1, wherein said sensor is a camera.

31. The system of claim 30, wherein said camera is a single-lens reflex camera.

32. The system of claim 30, wherein said camera is a digital camera.

33. The system of claim 30, wherein said camera is an infrared camera.

34. A method for landing an unmanned aerial vehicle, comprising:
(i) capturing an image in the direction of movement of said unmanned aerial vehicle;
(ii) analyzing said image to determine whether said image includes a possible target;
(iii) assessing the dimensions of said possible target and comparing said dimensions of said possible target to the known dimensions of an actual target, to determine a current glideslope and a current lineup angle; and
(iv) forcing said vehicle to adjust its altitude, using said current glideslope, and to adjust its alignment, using said current lineup angle.

35. The method of claim 34, wherein said method sends said current glideslope and said current lineup angle to an autopilot control loop to force said vehicle to adjust its said current glideslope and said current lineup angle.

36. The method of claim 35, wherein said capturing is accomplished using one or more cameras.

37. The method of claim 36, wherein at least one of said one or more cameras is a single-lens reflex camera.

38. The method of claim 36, wherein at least one of said one or more cameras is a digital camera.

39. The method of claim 36, wherein at least one of said one or more cameras is an infrared camera.

40. The method of claim 34, wherein said step of analyzing to determine whether said image includes a possible target is performed by a human operator.

41. The method of claim 34, wherein said step of analyzing to determine whether said image includes a possible target is performed by image processing.

42. The method of claim 41, wherein said image processing comprises:
(i) identifying said possible target by identifying a continuous region of the known color of said actual target;
(ii) deriving the outline of said possible target;
(iii) selecting at least three signature corners of said possible target;
(iv) comparing said at least three signature corners of said possible target to the known signature corners of said actual target; and
(v) determining whether said three signature corners of said continuous region substantially match said signature corners of said actual target.

43. The method of claim 42, wherein the outline of said possible target is identified by:
(i) converting said image into a binary mask, such that said continuous region is represented in said binary mask by a value which is the inverse of the value of all other colors represented in said binary mask;
(ii) using basic morphology operations to smooth the silhouette of said continuous region to form a more precise outline.

44. The method of claim 42, wherein said at least three signature corners are non-collinear signature corners.

45. The method of claim 44, wherein said at least three non-collinear signature corners establish a geometric two-dimensional plane of said possible target.

46. The method of claim 42, wherein one or more signature corners of said possible target is derived from a special marker.

47. The method of claim 42, wherein said step of analyzing to determine whether said possible target is an actual target is further verified by a human operator.

48. The method of claim 34, wherein said current glideslope is between 2 and 45 degrees above the horizon.

49. The method of claim 34, wherein said current glideslope is between 3 and 10 degrees above the horizon.

50. The method of claim 34, wherein the entire series of steps (i) through (iv) is repeated one or more times until said vehicle has landed.

51. The method of claim 50, wherein said capturing is accomplished using at least one camera.

52. The method of claim 51, wherein said camera is a single-lens reflex camera.

53. The method of claim 51, wherein said camera is a digital camera.

54. The method of claim 51, wherein said camera is an infrared camera.

55. The method of claim 51, wherein said current glideslope is determined as a function of the apparent height-to-width ratio of said target, as captured by said camera in the direction of movement of said vehicle.

56. The method of claim 55, wherein said height-to-width ratio is related to the current glideslope by the equation H/W=PAR*(h/w)*sin(α), wherein:
H=the apparent height of said target as captured in said image, measured in pixels;
W=the apparent width of said target as captured in said image, measured in pixels;
PAR=pixel aspect ratio of said electro-optic camera;
h=the actual height of said target;
w=the actual width of said target; and
α=current glideslope of said vehicle's current position.

57. The method of claim 56, wherein said current glideslope is determined by the equation α=sin⁻¹(H*w/(PAR*h*W)), wherein:
H=the apparent height of said target as captured in said image, measured in pixels;
W=the apparent width of said target as captured in said image, measured in pixels;
PAR=pixel aspect ratio of said electro-optic camera;
h=the actual height of said target;
w=the actual width of said target; and
α=current glideslope of said vehicle's current position.

58. The method of claim 51, wherein said lineup angle is determined by solving the system of equations generated by applying the equation
$$[ \begin{matrix}{S}_{X} \\ {S}_{Y} \\ {S}_{Z}\end{matrix} ] [ \begin{matrix}cos ( β ) & - sin ( β ) & 0 \\ sin ( β ) & cos ( β ) & 0 \\ 0 & 0 & 1\end{matrix} ] [ \begin{matrix}1 & 0 & 0 \\ 0 & cos ( α ) & - sin ( α ) \\ 0 & sin ( α ) & cos ( α )\end{matrix} ] = [ \begin{matrix}{D}_{X} \\ {D}_{Y} \\ 0\end{matrix} ] ,$$
wherein:
S_{X}, S_{Y}, S_{Z}=world coordinates for one signature corner of said target;
D_{X}, D_{Y}=unit vector of said signature corner of said target;
α=said current glideslope; and
β=said lineup angle,
to at least three signature corners of said target.

59. A method for preventing a vehicle from landing by executing a wave-off procedure, comprising:
(i) increasing the power of said vehicle;
(ii) forcing said vehicle to climb to a safe altitude; and
(iii) causing said vehicle to attempt another landing.

60. The method of claim 59, wherein said vehicle executes said wave-off procedure upon receipt of an instruction from a human operator.

61. The method of claim 59, wherein said vehicle executes said wave-off procedure upon the occurrence of one or more preprogrammed conditions.

62. The method of claim 61, wherein at least one of said one or more preprogrammed conditions is that said vehicle cannot sufficiently adjust its direction prior to an expected time to impact.

63. The method of claim 62, wherein said expected time to impact is determined by the equation
$${TTI}_{1} = \frac{{w}_{2} ( {t}_{2} - {t}_{1} )}{{w}_{2} - {w}_{1}} ,$$
wherein:
TTI₁=expected time to impact;
t₁=the time at which a first image is captured;
t₂=the time at which a subsequent image is captured;
w₁=the apparent width of said target as captured in said first image, measured in pixels; and
w₂=the apparent width of said target as captured in said subsequent image, measured in pixels.
